(19) United States
(12) Patent Application Publication
(10) Pub. No.: US 2006/0228570 A1
(43) Pub. Date: Oct. 12, 2006

(54) Reactor coated with a polymer

(76) Inventors: Stephen John Burns, Loughborough (GB); Ian Mark Fletcher, Loughborough (GB); Stephen Paul Metcalf, Loughborough (GB)

Correspondence Address: FISH & RICHARDSON P.C., P.O BOX 1022, MINNEAPOLIS, MN, 55440-1022, US

(21) Appl. No.: 10/554,967

(22) PCT Filed: Apr. 26, 2004
(86) PCT No.: PCT/GB04/01775

§ 371 Date: Oct. 27, 2005

(30) Foreign Application Priority Data
Apr. 29, 2003 (SE) 0301260-6

(51) Int. Cl. B32B 15/08

(52) U.S. Cl. 428/461

(57) ABSTRACT

The invention relates to the use of a coated manufacturing vessel in pharmaceutical production. A polymer coating (ECTFE, PVDF, PFA) avoids the adhesion or sticking of compounds within the vessel.

The present invention relates to the use of a coated manufacturing vessel in pharmaceutical (MDI) production and its use with adhesive materials.

It is known that during the manufacture of ingredients of the pharmaceutical formulations can adhere to the surfaces of the manufacturing equipment. This is a potential problem when the formulation is dilute, the adhesive component is the active drug and therefore only a small amount of active drug substance is used. For example a drug such as formoterol (used as formoterol fumarate dihydrate) has a tendency to adhere to the surface of equipment used in its manufacture for pMDI's, and this results in significant losses of material (sometimes <15%). The adhesion may be time dependent so that large scale manufacturing taking several days or where the batches are left stirring can result in unpredictable deposition.

Overages of the active ingredient are allowed in limited amounts to compensate for this but as the adhesion is not reproducible, these overages may result in the variation of content of the active in the can and subsequent dosage of the drug from the pMDI.

In some circumstances the problem may be solved by manufacturing at sub-ambient temperature, and it is known in the art that optimising the manufacturing temperature may improve the product (Drug delivery to the Lungs, 1997, Production Scale Optimisation of the Manufacturing Process for HFA-134a metered Dose Inhaler Containing Both Salmeterol and Fluticasone propionate, S J Duquemin et al) but this necessitates the use of cooling equipment, the cost of which escalates as the scale of the manufacture increases. Also, using sub-ambient temperature manufacturing procedures has the possibility of affecting the behaviour of other ingredients, so sub-ambient procedures are best avoided.

The problem becomes even more significant if the ingredient is dilute as the losses constitute a greater proportion of the added amount than if there was a large amount added initially, also if the ingredient is expensive.

It has now been found that coating of the manufacturing equipment reduces losses of drug substance and negates the use of subambient temperatures for manufacture where one or more of the ingredients of the mixture have a tendency to adhere to a conventional vessel surface.

In addition, cleaning of the equipment after use was found to be significantly easier than from an uncoated vessel where, due to the adhesion of ingredient to the uncoated surface, the cleaning was time-consuming. Efficient cleaning of pharmaceutical equipment is required under Good Manufacturing Practice.

In a first aspect the invention therefore provides use of a coated manufacturing vessel in the manufacture of a pharmaceutical formulation comprising a drug substance and pharmaceutically acceptable excipients.

Preferably the coated manufacturing vessel is used in the manufacture of a pharmaceutical formulation for a pMDI.

Preferably the coated manufacturing vessel is used in the manufacture of a pharmaceutical formulation for a pMDI, preferably wherein the active drug substance is formoterol fumarate dihydrate.

The vessels and processes of the invention are applicable to pressurised and non-pressurised manufacture e.g. aqueous suspensions for nebulisation, substances known to adhere to container surfaces esp steel e.g. proteins, antibodies.

As a further embodiment, the coating need not be limited to the vessel only, but stirrers, valves, tubing and any other equipment in the flow or in contact with the formulation mixture.

The vessel geometry was optimised for coating so that no voids were present where coating was difficult to apply and alterations were made to the standard design to prevent peeling of the coating from surfaces such as baffles and stirrer blades.

The coating can be any suitable alternative low surface energy coatings such as ECTFE (Ethylene Chloro-trifluoroethylene) PVDF (Polyvinylidene fluoride), and PFA (Perfluoroalkoxy) but the coating material is only limited by the suitablility of the coating for manufacturing using pharmaceutical formulations (for example no leaching into, or contamination of, the formulation).

The manufacturing vessel is preferably coated with a PFA coating, preferably using a process described below. Preferably the vessel is a stainless steel vessel.

The invention is especially useful where the mixture is dilute and therefore the losses small but significant.

The following examples and data illustrate the invention.

Vessel Design and Coating Procedure

A suitable vessel is made from 316L Stainless steel, fabricated to British standard BS 5500 Category 2.

A suitable coating procedure is:
Heat the vessel up to approx 400° C. to burn off any manufacturing residues
Apply a solvent based primer to the bare metal
Heat the vessel to approx 400° C. to cure the primer in place
Coat the vessel with a thin layer of PFA polymer—the vessel is electrostatically charged, and the PFA applied as an inversely charged powder.
Heat the vessel to approx 400° C. to sinter the PFA onto the primer
Repeat until a layer approx 0.5 mm thick is build up.
Test using a Holiday Detector—a commercially available tool for testing coating integrity. Measured conductivity between the vessel wall and the inside of the vessel. Good coat=no electrical conduction

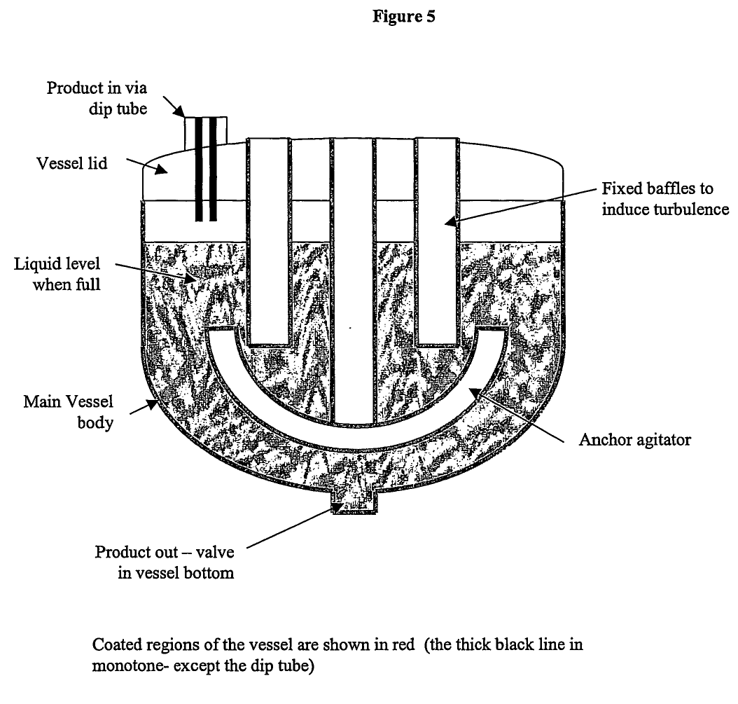

The invention applies to any design of vessel, one example of such a vessel, is represented by FIG. 5

Process Conditions for pMDI Production Using the Coated Vessel.

A manufacturing process for Formoterol MDI HFA-134a:227 (75:25) blend was followed for the coated vessel. The coated vessel was used at a 20° C. No propellant headspace overage was required. Pressure filling was used, but the invention is not limited to pressure filling.

The normal manufacturing procedure was followed except that the temperature of production was 20° C. not the more usual 12 C. The lower temperature had been used previously as adhesion of components was reduced and the filling of and therefore dosing from, the canister was more reproducible.

Using the procedure above, a batch of pressurised inhalers was produced using the formulation given in Example 1 below:

### EXAMPLE 1

Quantity

| | | Theoretical | |
|---|---|---|---|
| Components | % w/w | per batch | |
| Formoterol fumarate | 0.0167 | 5.01 | g* |
| dihydrate micronised, | | | |
| conditioned | | | |
| Polyethylene Glycol 1000 | 0.10 | 30 | g |
| Ph. Eur. USP/NF | | | |
| Povidone (PVP) K-25 | 0.001 | 0.3 | g |
| Propellant HFA-227 | 25 | 7.5 | kg |
| Propellant HFA-134a | to 100 | to 30 | kg |

All previous batches had been manufactured using an uncoated 30 Litre pressure vessel, some at 12° C., others at 20° C. Manufacturing time was normally 2 days, as was the case for this batch.

Product was filled into coated aerosol cans purged with propellant HFA-227, and crimped with a metering valve.

The results were compared with previous 30 Litre Giusti batches manufactured at ambient and sub-ambient temperatures.

Visual Observations

Observations were made through the sight glass on the vessel lid at various times throughout the batch. Deposition on the coated surfaces of the vessel side, stirrer and baffles was minimal. Three slight tidemarks were visible on the vessel side where the suspension had been left stirring overnight. No tidemarks were visible on the stirrer or baffles. The above observations were in contrast with batches made in a non-coated vessel, where tidemarks were clearly visible on all parts of the vessel.

Analysis of Results

The concentrations of Formoterol from samples taken at various points through the batch are given in Table 2.

TABLE 2
Formoterol Fumarate Dihydrate Concentration Through the Batch

| | | | | |
|---|---|---|---|---|
| Amount of | 4.0 | 13.0 | 14.0 | 24.0 |
| Suspension Used (kg) | | | | |
| Time after drug | 18.5 | 20.5 | 43.0 | 45.5 |
| addition (hrs) | | | | |
| Mean* Concentration | 0.0163 | 0.0155 | 0.0154 | 0.0151 |
| (% w/w) | | | | |

*based on a mean of three determinations

The above Table 2 shows that the concentration of active remains reasonably constant throughout the procedure.

If the mean concentration of Formoterol at any one point is divided by the theoretical concentration (based on weight added, in this case 0.0170% w/w) and multiplied by 100 then the % Formoterol concentration in the bulk mixture is given in Table 3.

TABLE 3
% Actual Formoterol Fumarate Dihydrate
Concentration Through the Batch

| | | | | |
|---|---|---|---|---|
| Amount of | 4.0 | 13.0 | 14.0 | 24.0 |
| Suspension Used (kg) | | | | |
| Time after drug | 18.5 | 20.5 | 43.0 | 45.5 |
| addition (hrs) | | | | |
| Mean* Concentration | 95.88 | 91.18 | 90.59 | 88.82 |
| (%) | | | | |

*of three cans per point.

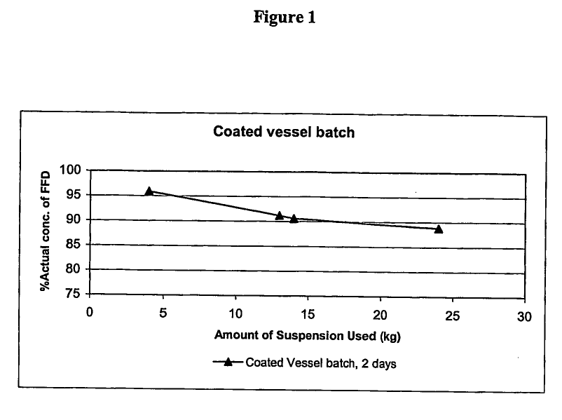

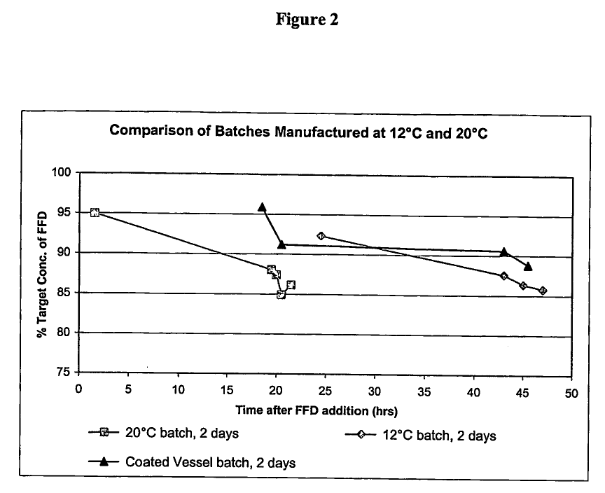

These values are plotted in FIGS. 1 and 2.

The data shows a 4% loss of Formoterol immediately after component addition and a further 7% drop in the Formoterol concentration over 2 days. However, significantly, negligible losses occurred when the mixture was held in the vessel for a significant time without processing. This is in contrast to previous batches and shows that the mixture can be left stirring overnight without loss in this type of vessel.

Also normally it is expected that the concentration of ingredients will increase as the level of mixture reduces due to propellant vapourising into the vessel headspace. This does not happen in the case of adhesive substances, because as the substance is deposited on the vessel walls the concentration decreases in the bulk. This process is unpredictable in the uncoated vessel but is more predicable in the coated vessel as can be seen in the graphical representation.

This loss of ingredient is particularly significant where the amount is low ie dilute mixtures or suspensions as the loss on a large surface becomes more significant as the concentration of component decreases.

Comparison with Other Batches

TABLE 4
Losses of Active During the Manufacturing Process

| | Temperature | Duration | Loss of | Loss of | Overall Loss of |
|---|---|---|---|---|---|
| | of | of Filling | Formoterol at | Formoterol | Formoterol at |
| | Manufacture | Period | Start of Filling | During Filling | End of Batch |
| Vessel Type | (° C.) | (days) | (% w/w) | (% w/w) | (% w/w) |
| Uncoated | 12 | 2 | 10.76 | 1.27 | 12.03 |
| Uncoated | 12 | 2 | 7.69 | 6.51 | 14.20 |
| Uncoated | 20 | 2 | 5.03 | 8.81 | 13.84 |
| Coated | 20 | 2 | 4.12 | 7.06 | 11.18 |

Table 4 shows that the coated vessel batch has the lowest overall loss of Formoterol at the end of the batch. The fall in concentration of Formoterol was found to be less than similar batches at 12 and 20 C.

Interpretation of the Results

Using a manufacturing vessel all parts of which have been coated with a layer of material, which prevents any formulation component coming into the contact with any untreated surface, reduces the losses of that component onto the surfaces of the vessel.

It also results in a more predictable manufacturing process and is easier to clean than a corresponding uncoated vessel.

FIG. 2 shows a Plot of % Formoterol Fumarate Dihydrate Concentration through the Batch against Amount of Suspension Used

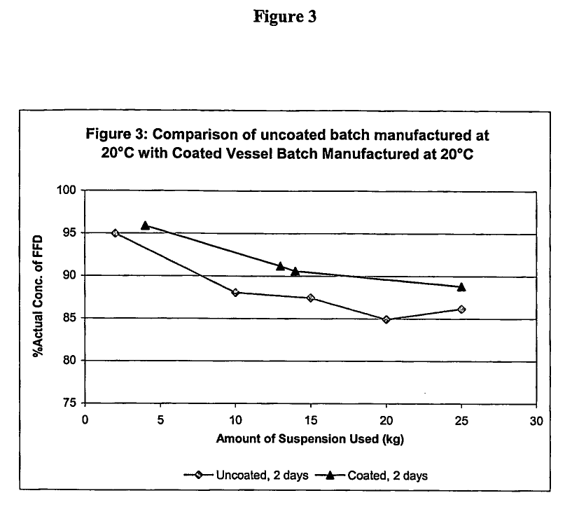

FIG. 3 shows a Plot of % Formoterol Fumarate Dihydrate Concentration compared to theoretical through the Batch against Time After Drug Addition

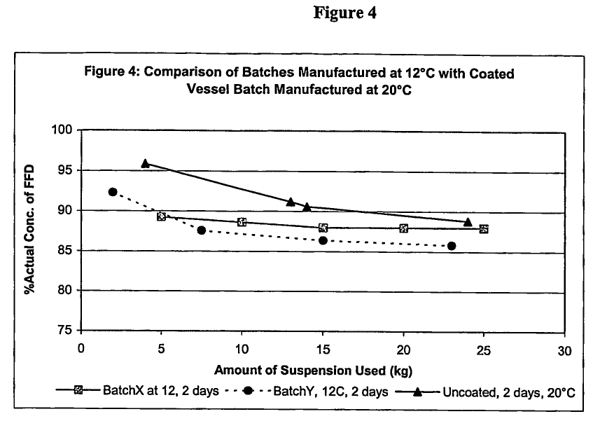

FIG. 4: shows a smooth profile for Formoterol concentration through the coated vessel batch.

FIG. 5: shows that the batch using the coated vessel has less loss at ambient compared with batches in uncoated vessel at sub-ambient

1. Use of a coated manufacturing vessel in the manufacture of a pharmaceutical formulation comprising a drug substance and pharmaceutically acceptable excipients.

2. Use according to claim 1 in the manufacture of a pharmaceutical formulation for a pMDI.

3. Use according to claim 1 or 2 in which the pharmaceutical formulation is a suspension for inhalation.

4. Use according to any one of claims 1 to 3 wherein the manufacture is carried out under pressurised conditions.

5. Use according to any one of claims 1 to 3 wherein the manufacture is carried out under non-pressurised conditions.

6. Use according to any one of claims 1 to 5 wherein the drug substance is formoterol fumarate dihydrate.

7. Use according to any one of claims 1 to 6 wherein the vessel is a stanless steel vessel.

8. Use according to any one of claims 1 to 7 wherein the coating is ECTFE, PVDF or PFA.

9. Use according to any one of claims 1 to 7 wherein the coating is PFA.

10. A manufacturing vessel characterised in that the vessel is coated to reduce adhesion of drug substance.

11. A stainless steel vessel according to claim 10 wherein the coating is ECTFE, PVDF or PFA.

12. A manufacturing vessel according to claim 10 wherein the coating is PFA.

13. A manufacturing vessel according to claim 11 or 12 which further includes coated piping, valves and accessories.
